(19) United States
(12) Patent Application Publication
(10) Pub. No.: US 2026/0119966 A1
(43) Pub. Date: Apr. 30, 2026

(54) RELATIONSHIP EMBEDDINGS USING WEAK SUPERVISION LABELS

(71) Applicant: Microsoft Technology Licensing, LLC, Redmond, WA (US)

(72) Inventors: Bixing Yan, Santa Clara, CA (US); Yafei Wei, Sunnyvale, CA (US); Da Xu, Belmont, CA (US); Rakesh Malladi, Campbell, CA (US); Keqing Liang, Cupertino, CA (US)

(21) Appl. No.: 18/925,708

(22) Filed: Oct. 24, 2024

(51) Int. Cl. G06N 20/00

(52) U.S. Cl. CPC G06N 20/00

(57) ABSTRACT

Methods, systems, and apparatuses include receiving network data for nodes of a graph network of an online system. Logging data is received for entities associated with the nodes Weakly labeled data is generated by filtering the logging data using the network data. Training data is generated for a relationship scoring machine learning model. The relationship scoring machine learning model is trained to determine relationship scores for the nodes by using the training data. Input data is generated for the trained relationship scoring machine learning model. The trained relationship scoring machine learning model is coupled to an input of a recommendation system to provide a recommendation.

### TECHNICAL FIELD

The present disclosure generally relates to machine learning, and more specifically, relates to relationship embedding generation approaches to machine learning.

### BACKGROUND ART

Machine learning is a category of artificial intelligence. In machine learning, a model is defined by a machine learning algorithm. A machine learning algorithm is a mathematical and/or logical expression of a relationship between inputs to and outputs of the machine learning model. The model is trained by applying the machine learning algorithm to input data. A trained model can be applied to new instances of input data to generate model output. Machine learning model output can include a prediction, a score, or an inference, in response to a new instance of input data. Application systems can use the output of trained machine learning models to determine downstream execution decisions, such as decisions regarding various user interface functionality.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a relationship embedding determination component in accordance with some embodiments of the present disclosure.

FIG. 2 illustrates another example computing system that includes a relationship embedding determination component in accordance with some embodiments of the present disclosure.

FIG. 3 illustrates another example computing system that includes a relationship embedding determination component in accordance with some embodiments of the present disclosure.

FIG. 4 illustrates another example computing system that includes a relationship embedding determination component in accordance with some embodiments of the present disclosure.

FIG. 5 illustrates an example computing system that includes a relationship embedding determination component in accordance with some embodiments of the present disclosure.

FIG. 6 illustrates an example computing system that includes a weak supervision labeling component in accordance with some embodiments of the present disclosure.

FIG. 7 is a flow diagram of an example method to generate relationship embeddings using weak supervision labels in accordance with some embodiments of the present disclosure.

FIG. 8 is a block diagram of an example computer system in which embodiments of the present disclosure can operate.

### DETAILED DESCRIPTION

Conventional recommendation systems generate recommendations based on affinity metrics between an entity receiving a recommendation and the recommended content. These affinity metrics are determined using supervised methods that require large amounts of data to accurately determine recommendations. These systems also cause overfitting by forcing affinity metrics to follow labeled data assuming that the underlying relationships between the entity receiving the recommendation and the recommended content closely match the representations as presented by the labeled data. However, in online social networks, relationships are not solely determined by whether users interact with a specific type of content from another user. Due to the abstract nature of relationships, methods for determining these relationships using supervising learning fail to accurately represent the true nature of the relationship and often include biases based on the labeled data. Furthermore, for users without any previous interactions, this lack of data presents a cold start problem, resulting in a lack of recommendations and therefore a lack of interactions to form the basis for future recommendations.

A recommendation system using relationship scores based on weakly labeled data, as described herein includes a number of different components that alone or in combination address the above and other shortcomings of the conventional machine learning systems, particularly when applied to environments with large online social networks. For example, by using weak supervision methods and weakly labeled data, the relationship scoring machine learning model is trained to determine relationship scores that are related to the weakly labeled data without forcing the relationship scores to align with the weakly labeled data. This results in a system that can more quickly determine accurate relationship scores for two users. Additionally, the system can filter the interactions included in the weakly labeled data to present data that is more likely to correspond with personal relationships, thereby bolstering the system's ability to quickly converge on accurate relationship scores. Finally, the system can use autoencoder methods to generate new data for nodes with few or no interactions, resulting in some data for the weak labels allowing the system to overcome the cold start problem.

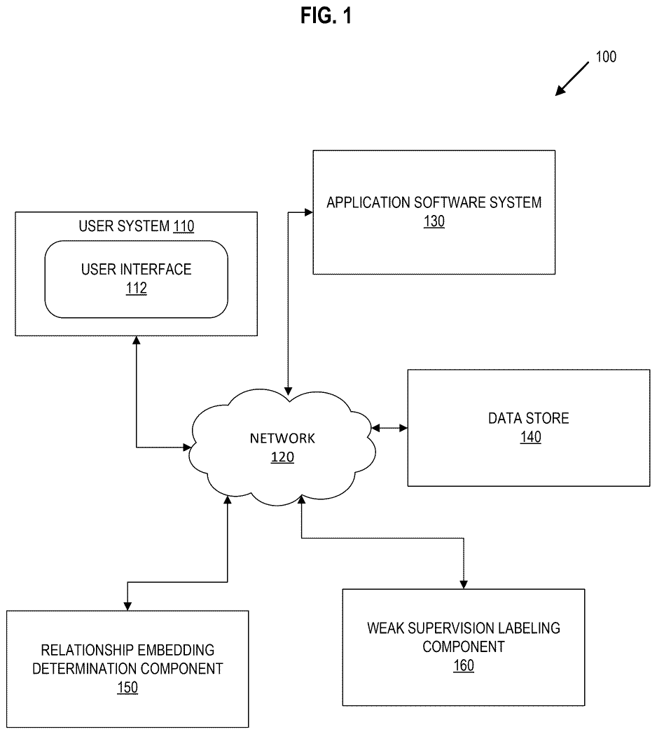

FIG. 1 illustrates an example computing system 100 that includes a relationship embedding determination component 150 in accordance with some embodiments of the present disclosure. In the embodiment of FIG. 1, computing system 100 includes a user system 110, a network 120, an application software system 130, a data store 140, a relationship embedding determination component 150, and a weak supervision labeling component 160. Each of these components of computing system 100 are described in more detail below. In some embodiments, the components of computing system 100 and their respective subcomponent are implemented on one or more of user devices, cloud servers and/or databases, and combinations thereof.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 can be or include a front-end portion of application software system 130.

User interface 112 is any type of user interface as described above. User interface 112 can be used to interact with a chat interface and view or otherwise perceive output that includes data produced by application software system 130. For example, user interface 112 can include a graphical user interface and/or a conversational voice/speech interface that includes a mechanism for entering a queries to a chat interface and viewing chat query results and/or other digital content. Examples of user interface 112 include web browsers, command line interfaces, and mobile apps. User interface 112 as used herein can include application programming interfaces (APIs).

Network 120 can be implemented on any medium or mechanism that provides for the exchange of data, signals, and/or instructions between the various components of computing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

Application software system 130 is any type of application software system that includes or utilizes functionality and/or outputs provided by relationship embedding determination component 150 and/or weak supervision labeling component 160. Examples of application software system 130 include but are not limited to online services including connections network software, such as social media platforms, and systems that are or are not be based on connections network software, such as general-purpose search engines, content distribution systems including media feeds, bulletin boards, and messaging systems, special purpose software such as but not limited to job search software, recruiter search software, sales assistance software, advertising software, learning and education software, enterprise systems, customer relationship management (CRM) systems, or any combination of any of the foregoing.

A client portion of application software system 130 can operate in user system 110, for example as a plugin or widget in a graphical user interface of a software application or as a web browser executing user interface 112. In an embodiment, a web browser can transmit an HTTP request over a network (e.g., the Internet) in response to user input that is received through a user interface provided by the web application and displayed through the web browser. A server running application software system 130 and/or a server portion of application software system 130 can receive the input, perform at least one operation using the input, and return output using an HTTP response that the web browser receives and processes.

While not specifically shown, it should be understood that any of user system 110, application software system 130, data store 140, relationship embedding determination component 150, and weak supervision labeling component 160 includes an interface embodied as computer programming code stored in computer memory that when executed causes a computing device to enable bidirectional communication with any other of user system 110, application software system 130, data store 140, relationship embedding determination component 150, and weak supervision labeling component 160 using a communicative coupling mechanism. Examples of communicative coupling mechanisms include network interfaces, inter-process communication (IPC) interfaces and application program interfaces (APIs).

Data store 140 can include any combination of different types of memory devices. Data store 140 stores digital data used by user system 110, application software system 130, relationship embedding determination component 150, and/or weak supervision labeling component 160. Data store 140 can reside on at least one persistent and/or volatile storage device that can reside within the same local network as at least one other device of computing system 100 and/or in a network that is remote relative to at least one other device of computing system 100. Thus, although depicted as being included in computing system 100, portions of data store 140 can be part of computing system 100 or accessed by computing system 100 over a network, such as network 120.

Each of user system 110, application software system 130, data store 140, relationship embedding determination component 150, and weak supervision labeling component 160 is implemented using at least one computing device that is communicatively coupled to electronic communications network 120. Any of user system 110, application software system 130, data store 140, relationship embedding determination component 150, and weak supervision labeling component 160 can be bidirectionally communicatively coupled by network 120. User system 110 as well as one or more different user systems (not shown) can be bidirectionally communicatively coupled to application software system 130.

A typical user of user system 110 can be an administrator or end user of application software system 130, relationship embedding determination component 150, and/or weak supervision labeling component 160. User system 110 is configured to communicate bidirectionally with any of application software system 130, data store 140, relationship embedding determination component 150, and/or weak supervision labeling component 160 over network 120.

The features and functionality of user system 110, application software system 130, data store 140, relationship embedding determination component 150, and weak supervision labeling component 160 are implemented using computer software, hardware, or software and hardware, and can include combinations of automated functionality, data structures, and digital data, which are represented schematically in the figures. User system 110, application software system 130, data store 140, relationship embedding determination component 150, and weak supervision labeling component 160 are shown as separate elements in FIG. 1 for ease of discussion but the illustration is not meant to imply that separation of these elements is required. The illustrated systems, services, and data stores (or their functionality) can be divided over any number of physical systems, including a single physical computer system, and can communicate with each other in any appropriate manner.

The relationship embedding determination component 150 generates relationship embeddings for pairs of actors and recipients in a social network. For example, relationship embedding determination component 150 generates a relationship score using relationship embeddings based on labels generated through weak supervision and features of the actors and recipients. Further details regarding the operations of relationship embedding determination component 150 are described below.

The weak supervision labeling component 160 generates weakly labeled data for an online social network using network data for interactions on the social network. Further details regarding the operations of weak supervision labeling component 160 are described below.

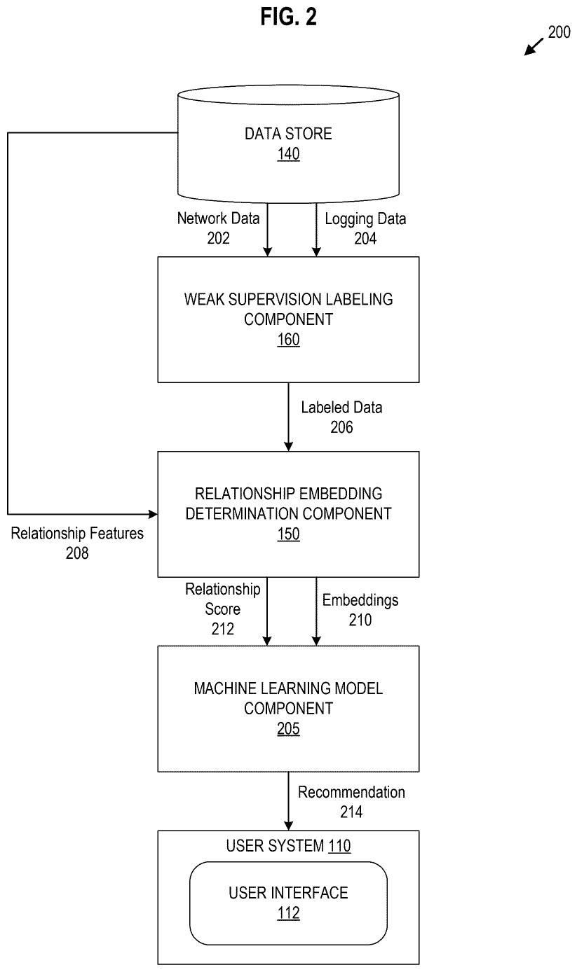

FIG. 2 illustrates another example computing system 200 that includes a relationship embedding determination component in accordance with some embodiments of the present disclosure. As shown in FIG. 2, computing system 200 also includes data store 140, weak supervision labeling component 160, machine learning model component 205, and user system 110.

As shown in FIG. 2, weak supervision labeling component 160 receives network data 202 and logging data 204 from data store 140. Weak supervision labeling component 160 is configured to generate weak labels for relationships between a pair of an actor and a recipient. Actors and recipients are terms for nodes of an online social network that can interact with each other. For example, an actor can represent a first user of an online social network and a recipient can represent a second user of an online social network. These users can each be represented in a graph network (e.g., a graph neural network) as a node connected by edges to other nodes. In such an example, the edges represent linking actions or attributes of the nodes. Two nodes that share a common attribute (e.g., two users who attended the same college) are therefore connected by an edge represented that shared attribute. Actor and recipient nodes can also be represented by other entities of the online social network. For example, a recipient node can be represented by a company. In such an example, an actor node represented by a user employed by the company will have a shared edge with the recipient node represented by the company.

The term weak is used herein to describe the relationship between the label (also called a weak signal) generated by weak supervision labeling component 160 used to train the machine learning models (e.g., machine learning models of relationship embedding determination component 150) and the actual target label (also called a target signal). For example, a weak signal, such as an interaction history between two nodes is weakly correlated with the actual relationship between the people and/or entities represented by the nodes. By using these weak labels, the machine learning models (e.g., machine learning models of relationship embedding determination component 150) are trained to represent the actual relationship without being overfit and forced to represent the relationship only as represented by the interaction history. This weak labeling approach is therefore very beneficial over conventional methods when used to calculate quantities that are not directly measurable (e.g., relationship and relationship strength).

Weak supervision labeling component 160 receives network data 202 representing the nodes of the online social network and their relationships and receives logging data 204 including actions and interactions of the nodes of the online social network. For example, network data 202 includes data modeling the relationships between nodes of the online social network. In one embodiment, network data 202 includes node embeddings for the actor node and the recipient node. These node embeddings are representations of each of the node's relative location in the graph network including that node's relationships to other nodes. Accordingly, the more shared attributes and/or relationships between two nodes, the more similar their respective embeddings. In some embodiments, network data 202 includes state data about the nodes and/or the entities they represent in the graph network. For example, network data 202 includes information from a user profile of a user represented by the actor node. In some embodiments, this state data can include, for example, a multi-dimensional vector representing the node (e.g., features of the node) and its relationship to other nodes in the graph network (e.g., shared edges, etc.) at a given time. Logging data 204 represents past interactions for nodes of the graph network and/or the entities they represent. For example, logging data 204 can include a history of past interactions (e.g., a user liking another user's post, sending another user a message, commenting on another user's post, etc.). Logging data 204 can include information on when these actions occurred, the kind of action that occurred, a channel through which these actions occurred, etc. For example, logging data 204 can include a timestamp that a user represented by the actor node liked a post by a user represented by a target node. In such an example logging data 204 could also include an identifier for the action (e.g., a like), the channel through which the like occurred (e.g., on the user's news feed), and similar information. In some embodiments, logging data 204 also includes information about the post that was the target of the action. For example, logging data 204 can include information indicating that the post was a celebratory post (e.g., a post celebrating a work anniversary) as opposed to a post with interesting content about a certain topic. This data is used to train the machine learning model to better understand the correlations between the action and the relationship between the actor and recipient. For example, a user could routinely like posts by another user because the other user posts content that is very informative and interesting. This relationship differs from a relationship where a user routinely likes posts by another user because they are close friends and/or relatives. By using this kind of information in the logging data 204 and accordingly in the labeled data 206, the system is able to generate more accurate relationship embeddings for pairs of users and therefore can more quickly generate quality recommendations for a user.

Weak supervision labeling component 160 generates labeled data 206 from network data and logging data 204. For example, weak supervision labeling component 160 generates labeled data 206 including the interactions between the shared attributes of an actor node and a target node. In some embodiments, rather than stacking the signals together, weak supervision labeling component 160 generates labeled data 206 as a signal including an actor, a recipient, and a relationship label. In such embodiments, the relationship label can represent the concatenation of the historical actions and/or shared attributes across different channels in a vector form. For example, rather than labeled data 206 including multiple signals such as (recipient, actor, channel1_action1), (recipient, actor, channel1_action2), and (recipient, actor, channel2_action1), weak supervision labeling component 160 generates labeled data 206 with a signal (recipient, actor, relationship_label) where relationship_label is represented as relationship_label=(channel1_action2, channel1_action2, channel2_action1). This results in labeled data 206 with a label that better describes an overall relationship between two nodes. As used herein, channels described different methods of interaction between a user and the online social network and/or between two users. For example, channels can include a news feed, messaging, and/or search. In some embodiments, labeled data 206 includes both impression and action information. For example, by including information on both what content a user was exposed to (e.g., impression) and content that a user interacted with (e.g., action), labeled data 206 can better capture the relationship between the nodes. In such embodiments, however, not all action data can be paired with impression data. For example, a user that performs a search for a specific entity includes action data with no corresponding impression data.

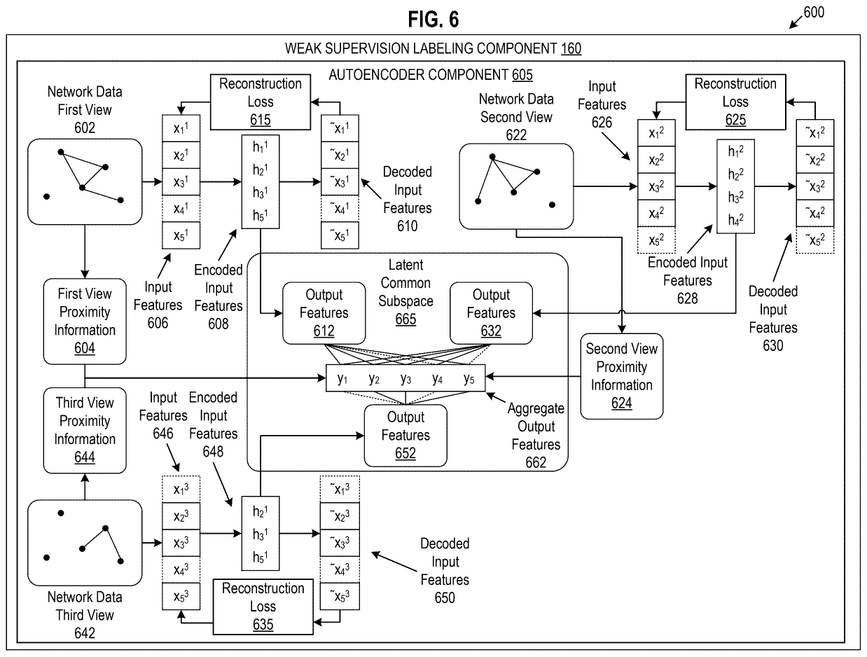

In some embodiments, weak supervision labeling component 160 filters logging data 204. For example, weak supervision labeling component 160 uses user data and/or data about the post from network data 202 and logging data 204 to filter out irrelevant interactions. In one embodiments, as explained above, logging data 204 can include information indicating that the post was a celebratory post (e.g., a post celebrating a work anniversary) as opposed to a post with interesting content about a certain topic. Weak supervision labeling component 160 can label posts based on the content of the post. For example, weak supervision labeling component 160 can label posts based on whether the post included useful content. In such an example, weak supervision labeling component 160 could filter out posts with useful content leaving posts that indicate a relationship between the user liking the post and the poster rather than a relationship between the user liking the post and the actual content of the post. In some embodiments, weak supervision labeling component 160 uses a natural language processing model to categorize/classify posts for filtering. Additionally, weak supervision labeling component 160 can filter out data using profile data of the actor and/or recipient nodes. For example, weak supervision labeling component 160 can retrieve profile data for a user associated with the actor node and a user associated with the recipient node. Weak supervision labeling component 160 can then filter out logging data 204 for interactions between users that have few or no shared attributes while keeping logging data 204 for interactions where the users have shared attributes (e.g., attended the same school, small age difference, etc.) Accordingly, weak supervision labeling component 160 can filter our logging data 204 to try to remove interactions that are not based (or are weakly based) on the relationship between two users. In some embodiments, weak supervision labeling component 160 generates features for labeled data 206 using generative machine learning models. For example, weak supervision labeling component 160 uses autoencoder methods to reconstruct missing and/or noisy features. Further details regarding weak supervision labeling component 160 are discussed with reference to FIG. 6. Weak supervision labeling component 160 sends the generated labeled data 206 to relationship embedding determination component 150.

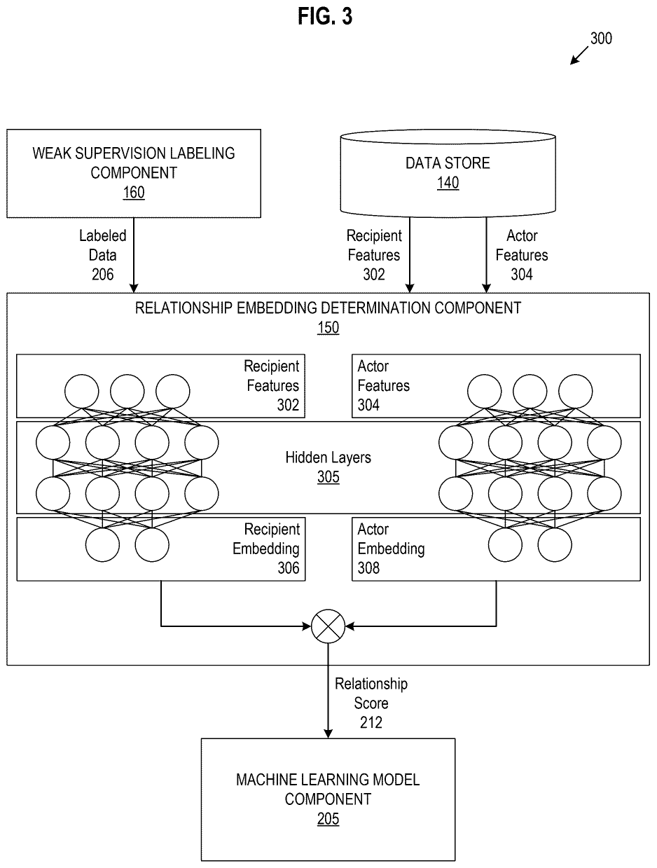

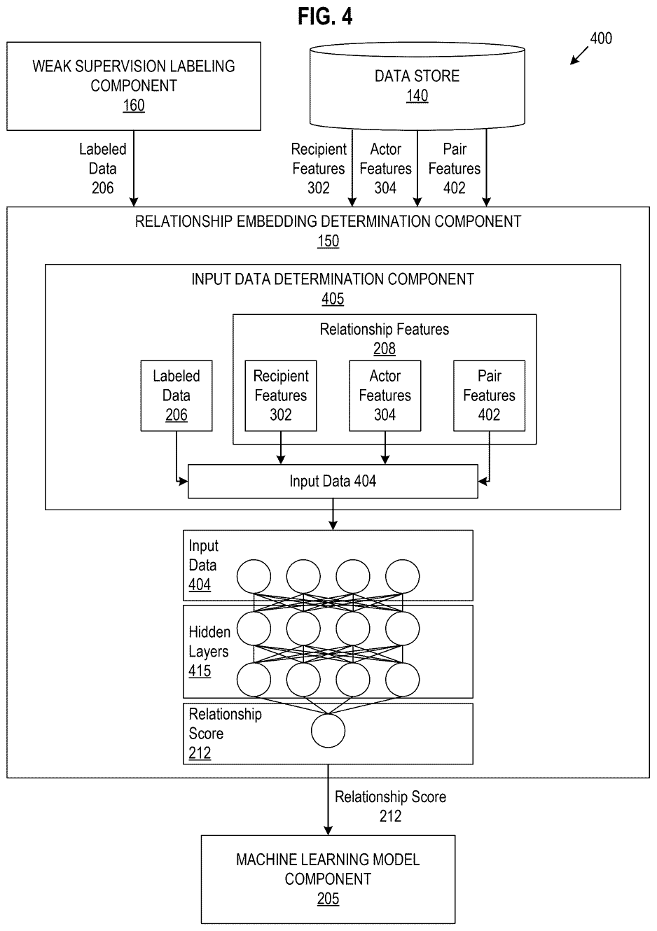

Relationship embedding determination component 150 receives labeled data 206 from weak supervision labeling component 160. In some embodiments, relationship embedding determination component 150 receives relationship features 208 from data store 140. Relationship features 208 can include features for each of the actor and recipient nodes (e.g., recipient features 302 and actor features 304 of FIG. 3) as well as pair features for the pair of the actor and recipient node (e.g., pair features 402 of FIG. 4). In some embodiments, relationship features 208 include state data about the nodes and/or the entities they represent in the graph network. For example, relationship features 208 includes a multi-dimensional vector for each of the actor node and recipient node (e.g., features of the actor node and features of the recipient node). Relationship features 208 can also include information about the relationships between each of the actor node and the recipient node and other nodes of the graph network (e.g., shared edges, etc.). In some embodiments, relationship features 208 includes shared features and/or relationships between features of the nodes (e.g., whether two users attended the same school, the age difference between two users, the difference in professional level between two users, etc.). These features and/or feature relationships allow the system to gain better insight into the kind of relationship that exists between two users. For example, two users who attended the same college and graduated the same year (and/or are similar ages) are more likely to have a colleague relationship whereas two users who have a large age difference and/or a large difference in professional experience level are more likely to have a managerial relationship.

Relationship embedding determination component 150 generates a relationship score for pairs of actor and recipient nodes using labeled data 206 and relationship features 208. For example, as described in more detail with reference to FIGS. 3-5, relationship embedding determination component 150 can use the labeled data 206 and relationship features 208 as inputs to a machine learning model (e.g., a neural network machine learning model) and generate relationship score 212 representing a relationship between the two nodes. In some embodiments, the relationship representation determined by relationship embedding determination component 150 can be expressed as a collection of relationship representations across different channels of the online social network. For example, the relationship representation (S*(r, a) for a recipient r and an actor a) can be represented by the following equation: S*(r, a)=Σ_{c}w_{c}Ŝ_{c}(xᵣ,xₐ,x_{(r,a)}; θ_{c}*), where c represents the channel, w_{c} represents a learned weight for that channel, Ŝ_{c} represents the estimated relationship between the recipient r and the actor a for the channel c, xᵣ represents the features of recipient r, xₐ represents the features of recipient a, x_{(r,a)} represents the pair features of the pair of r and a, and θ_{c}*represents an approximation for a projection function that optimizes the loss for that channel c. For example, θ_{c}* can be represented by the equation θ_{c}*=argmin_{θ}L_{c}[Ŝ_{c} (xᵣ, xₐ, x_{(r,a)}; θ_{c}), Y_{c}] where L_{c} is the loss function for the channel c and Y_{c} is the weak label for channel c generated by weak supervision labeling component 160. Accordingly, relationship embedding determination component 150 generates relationship score 212 that is the sum of channel relationship scores Ŝ_{c} calculated based on minimizing the loss of the approximated relationship for that channel Ŝ_{c} given the weak label Y_{c} without explicitly making the loss the difference between Ŝ_{c} and Y_{c}. This weak learning approach allows the weak label to guide the machine learning model without forcing the output of the machine learning model (e.g., the relationship score) to match the label. As explained above, this results in a machine learning model that is able to more accurately represent the actual relationship between two users. Further details regarding relationship embedding determination component 150 are discussed with reference to FIGS. 3-5.

In some embodiments, relationship embedding determination component 150 generates embeddings 210 for the nodes. For example, relationship embedding determination component 150 generates an actor node embedding for the actor node including a representation of the relationship between the actor node and the recipient node. In such examples, relationship embedding determination component 150 can generate embeddings for the nodes of a graph network that represent the relationships between that node and multiple other nodes of the graph network. Relationship embedding determination component 150 sends embeddings 210 and relationship score 212 to machine learning model component 205.

Machine learning model component 205 receives embeddings 210 and relationship score 212 and generates recommendation 214. In some embodiments, machine learning model component 205 uses relationship score 212 to generate a recommendation. For example, machine learning model component 205 uses relationship score 212 as input data to generate a recommendation for a user based on their relationships with other users. Because recommendation 214 is generated using a relationship score 212 that more accurately represents the actual relationship between two users, machine learning model component 205 is able to more quickly provide a relevant recommendation 214 for the user (e.g., user of user system 110). For example, machine learning model component 205 is more likely to recommend celebratory posts for more personal relationships and more content-based posts for more professional relationships. Machine learning model component 205 sends recommendation 214 to user system 110.

User system 110 receives recommendation 214 from machine learning model component 205 and displays recommendation 214 on user interface 112. In some embodiments, the user of user system 110 can interact with the recommendation 214 presented on the user interface 112. For example, in response to user interface 112 displaying recommendation 214 as a post on the news feed of the user of user system 110, the user of user system 110 can like the post. In some embodiments, this interaction causes user system 110 to send logging data (e.g., logging data 204) to data store 140 (e.g., through application software system 130 of FIG. 1). Accordingly, the system can better learn the relationship between the user of user system 110 of other users of the online social network.

FIG. 3 illustrates another example computing system 300 that includes a relationship embedding determination component in accordance with some embodiments of the present disclosure. As shown in FIG. 3, computing system 300 also includes data store 140, weak supervision labeling component 160 and machine learning model component 205. Relationship embedding determination component 150 includes recipient features 302, actor features 304, hidden layers 305, recipient embedding 306, and actor embedding 308.

As shown in FIG. 3, in some embodiments, relationship embedding determination component 150 includes a two-tower machine learning model for generating a relationship score 212 between two nodes. For example, relationship embedding determination component 150 includes two independent towers, one for learning recipient embedding 306 using recipient features 302 and one for learning actor embedding 308 using actor features 304. In some embodiments, as shown in FIG. 3, each of these towers are represented as neural networks with hidden layers 305. The hidden layers 305 are trained to learn weights of aspects of each of recipient features 302 and actor features 304 and apply the learned weights during inference to generate each of recipient embedding 306 and actor embedding 308. For example, the two-tower machine learning model is modeled as independent multi-layer perceptron models trained on the respective features (e.g., recipient features 302 and actor features 304). In such an example, relationship score 212 may be determined according to the following equation: Ŝ_{c}(r, a)=MLP^{r}(xᵣ)·MLP^{a}(xₐ), where MLP^{r}(xᵣ) represents the output of the multi-layer perceptron for the recipient (e.g., recipient embedding 306) when applied to recipient features 302 (e.g., xᵣ) and where MLP^{a}(xₐ) represents the output of the multi-layer perceptron for the actor (e.g., actor embedding 308) when applied to actor features 304 (e.g., xₐ). In such an example, relationship score 212 is therefore the dot product of recipient embedding 306 and actor embedding 308. In some embodiments, relationship score 212 is represented as a binary classification probability (e.g., the probability of a personal relationship existing between actor and recipient). Although multi-layer perceptrons (MLPs) are explicitly mentioned, relationship embedding determination component 150 can include any kind or form of suitable neural networks including artificial feed forward neural networks and/or neural networks with non-linear activation functions. These descriptions are not intended to limit the use of recurrent neural networks, neural networks with linear activation functions, and/or other forms of machine learning models. Additionally, while hidden layers 305 are illustrated as including two layers with four nodes per layer, hidden layers 305 can include different numbers of layers and nodes per layer.

In some embodiments, as indicated in the equation notation, relationship score 212 is calculated with all channels sharing the same model structure and loss function (e.g., ∀c, L_{c} [ [symbol] (xᵣ, xₐ; θ_{c})]=L[Ŝ(xᵣ, xₐ; θ_{c}), Y_{c}]). In such embodiments, the parameters for all channels may be optimized globally with all channels sharding the same model parameter θ (e.g., θ_{c}*=argmin_{θ}S*(r, a; θ)). In some embodiments, relationship embedding determination component 150 trains the machine learning model (e.g., adjusts the weights of hidden layers 305) using a cross-entropy loss function. Accordingly, relationship embedding determination component 150 trains the hidden layers 305 to output a relationship score 212 that minimizes the cross-entropy between relationship score 212 and labeled data 206.

FIG. 4 illustrates another example computing system 400 that includes a relationship embedding determination component in accordance with some embodiments of the present disclosure. As shown in FIG. 4, computing system 400 also includes weak supervision labeling component 160, data store 140, and machine learning model component 205. Relationship embedding determination component 150 includes input data determination component 405, input data 404, hidden layers 415, and relationship score 212.

As shown in FIG. 4, relationship embedding determination component 150 receives labeled date 206 from weak supervision labeling component 160 as well as recipient features 302, actor features 304, and pair features 402 from data store 140. In some embodiments, input data determination component 405 generates input data 404 for training a machine learning model with hidden layers 415. For example, relationship embedding determination component 150 trains the machine learning model to adjust the weights of the hidden layers 415 based on input data 404 including training data. In some embodiments, input data determination component 405 generates input data 404 for performing inference using hidden layers 415 of the machine learning model to generate relationship score 212. For example, relationship embedding determination component 150 applies the hidden layers 415 (and their trained weights) to input data 404 including relationship features 208 and labeled data 206 to generate relationship score 212.

As shown in FIG. 4, in some embodiments, relationship embedding determination component 150 includes a machine learning model for estimating a relationship score 212 using input data 404 including recipient features 302, actor features 304, and pair features 402. For example, relationship embedding determination component 150 includes a multi-layer perceptron machine learning model to generate a relationship score 212 using recipient features 302, actor features 304, and pair features 402. In such an embodiment, relationship score 212 can be represented by the following equation: Ŝ(r, a)=MLP^{S}(xᵣ, xₐ, x_{(r,a)}), where MLP^{S} represents the multi-layer perceptron model for calculating relationship score 212, xᵣ represents recipient features 302, xₐ represents actor features 304, and x_{(a,r)} represents pair features 402 for the pair of actor and recipient. In some embodiments, the output relationship score 212 is a binary classification probability (e.g., the probability of a personal relationship existing between the actor and recipient). As mentioned above, although a multi-layer perceptron (MLP) is explicitly mentioned, relationship embedding determination component 150 can include any kind or form of suitable neural network including artificial feed forward neural networks and/or neural networks with non-linear activation functions. These descriptions are not intended to limit the use of recurrent neural networks, neural networks with linear activation functions, and/or other forms of machine learning models. Additionally, while hidden layers 415 is illustrated as including two layers with four nodes per layer, hidden layers 415 can include different numbers of layers and nodes per layer.

As mentioned above with reference to FIG. 3, in some embodiments, relationship score 212 is calculated with all channels sharing the same model structure and loss function (e.g., ∀c, L_{c} [ [symbol] (xᵣ, xₐ; θ_{c})]=L[Ŝ(xᵣ, xₐ; θ_{c}), Y_{c}]). In such embodiments, the parameters for all channels may be optimized globally with all channels sharding the same model parameter θ (e.g., θ_{c}*=argmin_{θ}S*(r, a; θ)). In some embodiments, relationship embedding determination component 150 trains the machine learning model (e.g., adjusts the weights of hidden layers 415) using a cross-entropy loss function. Accordingly, relationship embedding determination component 150 trains the hidden layers 415 to output a relationship score 212 that minimizes the cross-entropy between relationship score 212 and labeled data 206.

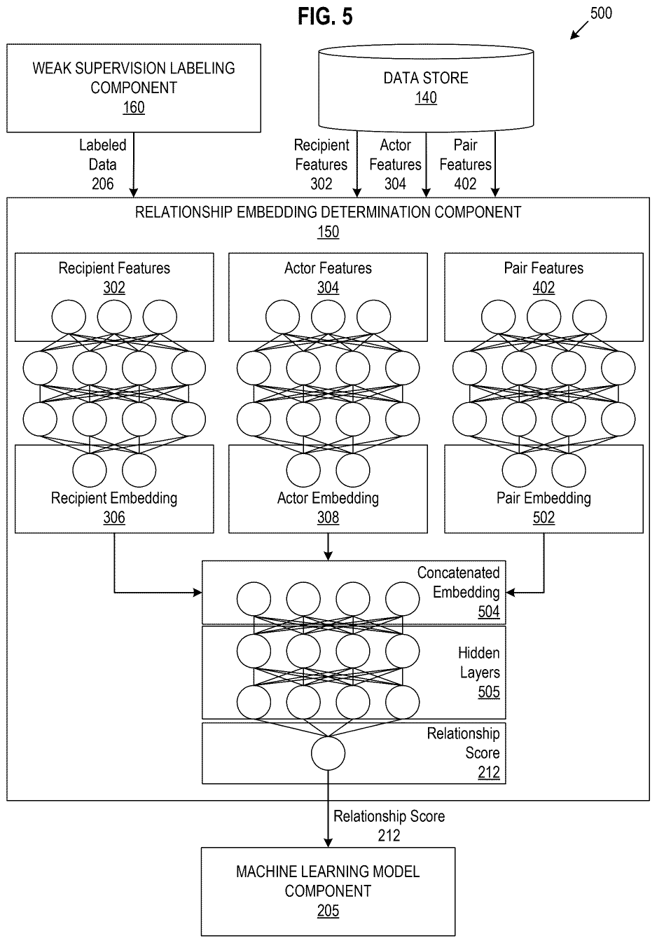

FIG. 5 illustrates another example computing system 500 that includes a relationship embedding determination component in accordance with some embodiments of the present disclosure. As shown in FIG. 5, computing system 500 also includes weak supervision labeling component 160, data store 140, and machine learning model component 205. Determination component 150 includes concatenated embedding 504, hidden layers 505, and relationship score 212.

As shown in FIG. 5, relationship embedding determination component 150 can include a multi-tower structure with machine learning models trained to generate each of recipient embedding 306, actor embedding 308, and pair embedding 502 as well as to generate relationship score 212 using concatenated embedding 504 including the generated recipient embedding 306, actor embedding 308, and pair embedding 502. For example, relationship embedding determination component 150 includes a multi-layer perceptron model trained to generate recipient embedding 306 from recipient features 302, a multi-layer perceptron model trained to generate actor embedding 308 from actor features 304, and a multi-layer perceptron model trained to generate pair embedding 502 from pair features 402. In such an example, the embeddings generated by these models (e.g., recipient embedding 306, actor embedding 308, and pair embedding 502) are used as input data (e.g., concatenated embedding 504) for a multi-layer perceptron model trained to generate relationship score 212 by applying the weights of hidden layers 505 to concatenated embedding 504.

In such an embodiment, relationship score 212 can be represented by the following equation: ŝ(r,a)=MLP^{S} (MLP^{r}(xᵣ), MLP^{a}(xₐ), MLP^{p}(x_{(r,a)})), where MLP^{S} represents the multi-layer perceptron model for calculating relationship score 212, MLP^{r} represents the multi-layer perceptron model for calculating recipient embedding 306, MLP^{a} represents the multi-layer perceptron model for calculating actor embedding 308, and MLP^{p} represents the multi-layer perceptron model for calculating pair embedding 502. In some embodiments, the output relationship score 212 is a binary classification probability (e.g., the probability of a personal relationship existing between the actor and recipient). As mentioned above, although multi-layer perceptrons (MLPs) are explicitly mentioned, relationship embedding determination component 150 can include any kind or form of suitable neural network including artificial feed forward neural networks and/or neural networks with non-linear activation functions. These descriptions are not intended to limit the use of recurrent neural networks, neural networks with linear activation functions, and/or other forms of machine learning models. Additionally, while hidden layers 505 is illustrated as including two layers with four nodes per layer, hidden layers 505 (and hidden layers of the recipient, actor, and pair machine learning models) can include different numbers of layers and nodes per layer.

As mentioned above with reference to FIG. 3, in some embodiments, relationship score 212 is calculated with all channels sharing the same model structure and loss function (e.g., ∀c, L_{c}[ [symbol] (xᵣ, xₐ: θ_{c})]=L[Ŝ(xᵣ, xₐ; θ_{c}), Y_{c}]). In such embodiments, the parameters for all channels may be optimized globally with all channels sharding the same model parameter θ (e.g., θ_{c}*=argmin_{θ}S*(r, a; θ)). In some embodiments, relationship embedding determination component 150 trains the machine learning model (e.g., adjusts the weights of hidden layers of recipient, actor, and pair machine learning models as well as hidden layers 505) using a cross-entropy loss function. Accordingly, relationship embedding determination component 150 trains the hidden layers to output a relationship score 212 that minimizes the cross-entropy between relationship score 212 and labeled data 206.

FIG. 6 illustrates another example computing system 600 that includes a weak supervision labeling component in accordance with some embodiments of the present disclosure. As shown in FIG. 6, weak supervision labeling component 160 includes an autoencoder component 605 which includes an autoencoder model trained to reconstruct aggregate output features 662 for nodes in a graph network (e.g., a graph neural network). For example, autoencoder component 605 can reconstruct missing and/or noisy features for nodes in a graph network. These techniques are especially useful for solving the cold start problem for nodes in a graph network. For example, autoencoder component 605 can be used to generate features for nodes that do not share an edge, share few edges, have limited interaction history, and/or have no interaction history. In such an example, the autoencoder techniques are applied to reconstruct features, embeddings, and/or relationship scores. Although autoencoder techniques are illustrated and described, different types of generative machine learning models (e.g., encoder/decoder and transformer models) may be used to generate the missing and/or noisy data.

Autoencoder component 605 includes a machine learning model trained to discover latent variables and reconstruct its own input by passing the input data through an encoding bottleneck which causes the machine learning model to learn to encode the data using the information most relevant for reconstructing the input data. For example, as shown in FIG. 6, autoencoder component 605 includes network data first view 602, network data second view 622, and network data third view 642. Each of these network view include information about a subset of nodes in a graph network. For example, for a graph network with nodes x₁, x₂, x₃, x₄, and x₅, with various connecting edges, network data first view 602 includes information about a first subset of connected nodes (e.g., x₁, x₂, x₃, and x₅), network data second view 622 includes information about a second subset of connected nodes (e.g., x₁, x₂, x₃, and x₄), and network data third view 642 includes information about a third subset of connected nodes (e.g., x₂, x₃, and x₅).

Autoencoder component 605 generates input features 606 using network data first view 602 which represent the nodes and their connections as illustrated in network data first view 602 (e.g., x₁ shares edges with xₐ and x₃, xₐ shares edges with x₁ and x₃, x₃ shares edges with x₁, x₂, and x₅, and x₅ shares edges with x₃). Autoencoder component 605 passes input features 606 through an encoder to generate encoded input features 608 as a compressed representation of input features 606. For example, autoencoder component 605 applies a dimensionality reduction to input features 606 to compress input features 606. In some embodiments, applying the encoder to input features 606 includes applying a neural network with fewer and fewer nodes for progressive layers of the neural network. As shown in FIG. 6, x₄¹ (e.g., the node x₄ in the network data first view 602) is surrounded by dotted lines to indicate that this node is not connected to the other nodes through shared edges in network data first view 602. Accordingly, in the encoded representation (e.g., encoded input features 608), a representation for x₄¹ is not included as it is not needed to explain the graph network shown in network data first view 602. Autoencoder component 605 then passes encoded input features 608 through a decoder to generate decoded input features 610. For example, autoencoder component 605 increases the dimensions of encoded input features 608 to generate decoded input features 610 with dimensions matching that of input features 606. In some embodiments, applying the decoder to encoded input features 608 includes applying a neural network with more and more nodes for progressive layers of the neural network. Autoencoder component 605 calculates a reconstruction loss 615 using differences between decoded input features 610 and input features 606. Autoencoder component 605 trains the encoder and decoder to minimize reconstruction loss 615 such that the encoder can produce a latent space representation (e.g., encoded input features 608) of input features 606 with the fewest possible dimensions (while preserving the most necessary information).

Autoencoder component 605 can apply the same techniques described above to network data second view 622 and network data third view 642 to generate aggregate output features 662 that includes information for all views of the network. For example, autoencoder component 605 generates input features 626 using network data second view 622 which represent the nodes and their connections as illustrated in network data second view 622 (e.g., x₁ shares edges with x₂, x₃, and x₄, xₐ shares edges with x₁ and x₃, x₃ shares edges with x₁ and x₂, and x₄ shares edges with x₁). Autoencoder component 605 passes input features 626 through an encoder to generate encoded input features 628 as a compressed representation of input features 626. As shown in FIG. 6, x₅² (e.g., the node x₅ in the network data second view 622) is surrounded by dotted lines to indicate that this node is not connected to the other nodes through shared edges in network data second view 622. Accordingly, in the encoded representation (e.g., encoded input features 628), a representation for x₅² is not included as it is not needed to explain the graph network shown in network data second view 622. Autoencoder component 605 then passes encoded input features 628 through a decoder to generate decoded input features 630. For example, autoencoder component 605 increases the dimensions of encoded input features 608 to generate decoded input features 630 with dimensions matching that of input features 626. In some embodiments, applying the decoder to encoded input features 628 includes applying a neural network with more and more nodes for progressive layers of the neural network. Autoencoder component 605 calculates a reconstruction loss 625 using differences between decoded input features 630 and input features 626. Autoencoder component 605 trains the encoder and decoder to minimize reconstruction loss 625 such that the encoder can produce a latent space representation (e.g., encoded input features 628) of input features 626 with the fewest possible dimensions (while preserving the most necessary information).

In another example, autoencoder component 605 generates input features 646 using network data third view 642 which represent the nodes and their connections as illustrated in network data third view 642 (e.g., x₃ shares edges with x₂, xₐ shares edges with x₃ and x₅, and x₅ shares edges with x₂). Autoencoder component 605 passes input features 646 through an encoder to generate encoded input features 648 as a compressed representation of input features 646. As shown in FIG. 6, x₁³ (e.g., the node x₁ in the network data third view 642) and x₄³ (e.g., the node x₄ in the network data third view 642) are surrounded by dotted lines to indicate that these nodes are not connected to the other nodes through shared edges in network data third view 642. Accordingly, in the encoded representation (e.g., encoded input features 648), representations for x₁³ and x₄³ are not included as they are not needed to explain the graph network shown in network data third view 642. Autoencoder component 605 then passes encoded input features 648 through a decoder to generate decoded input features 650. Autoencoder component 605 calculates a reconstruction loss 635 using differences between decoded input features 650 and input features 646. Autoencoder component 605 trains the encoder and decoder to minimize reconstruction loss 635 such that the encoder can produce a latent space representation (e.g., encoded input features 648) of input features 646 with the fewest possible dimensions (while preserving the most necessary information).

In some embodiments, autoencoder component 605 can use the trained autoencoder models to reconstruct missing and/or noisy features. For example, autoencoder component 605 can combine the encoded input features from each of the views in a latent common subspace 665 to generate aggregate output features 662 that represents the network more comprehensively. In some embodiments, autoencoder component 605 can use proximity information (e.g., first view proximity information 604, second view proximity information 624, and third view proximity information 644) to generate aggregate output features 662 in the latent common subspace 665. The latent common subspace 665 refers to the reduced dimension subspace that includes the reduced dimensional representation for all network data views. Because the latent subspace is common, autoencoder component 605 can generate aggregate output features 662 that includes information for all network data views.

The proximity information is used to retain information relating to the position of nodes of the network represented by network data first view 602, network data second view 622, and network data third view 642. For example, because each of the output features (e.g., output features 612, output features 632, and output features 652) is missing information relating to at least one of the nodes, the proximity information maintains the relationship between the output features and the node they represent. Autoencoder component 605 generates aggregate output features 662 that represent a comprehensive view of the network data. For example, because aggregate output features 662 includes information from each of the network data views, each of the network data views can be constructed using aggregate output features 662. Aggregate output features 662 thereby represents a view of the network data taking all of the view into account. Accordingly, autoencoder component 605 generates aggregate output features 662 using the encoded representation of input features for each of the network data views. For example, autoencoder component 605 generates aggregate output features 662 using output features 612, output features 632, and output features 652. As illustrated in FIG. 6, even though information is missing from some of the views (e.g., node x₄ edge information from network data first view 602), aggregate output features 662 includes such information by using output features 632 from a different view in the latent common subspace 665. In some embodiments, autoencoder component 605 uses aggregate output features 662 to generate one or more of network data 202, logging data 204, labeled data 206, and/or relationship features 208. For example, when logging data 204 does not include past interactions for a pair of nodes, weak supervision labeling component 160 can generate labeled data 206 using aggregate output features 662 generated by autoencoder component 605. Similarly, when network data 202 does not include shared edges for a pair of nodes, weak supervision labeling component 160 can generate labeled data 206 using aggregate output features 662 generated by autoencoder component 605.

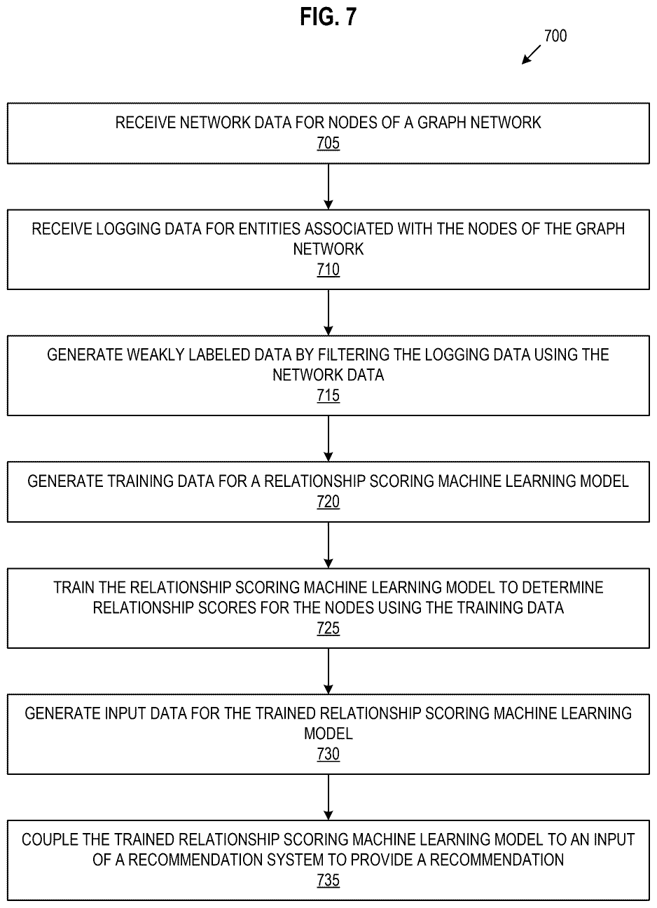

FIG. 7 is a flow diagram of an example method 700 to generate relationship embeddings using weak supervision labels in accordance with some embodiments of the present disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by relationship embedding determination component 150 of FIG. 1. In other embodiments, the method 700 is performed by weak supervision labeling component 160 of FIG. 1. In still other embodiments, parts of the method 700 are performed by relationship embedding determination component 150 and parts of the method 700 are performed by weak supervision labeling component 160. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 705, the processing device receives network data for nodes of a graph network. For example, weak supervision labeling component 160 receives network data 202 including node state data for an actor node and a recipient node of a graph network. In some embodiments, the node state data includes information about each of the nodes (e.g., features of the nodes) and information about each of the nodes' connections to other nodes (e.g., edges of the nodes). Further details regarding receiving network data for nodes of a graph network are discussed with reference to FIGS. 2-6.

At operation 710, the processing device receives logging data for entities associated with the nodes of the graph network. For example, weak supervision labeling component 160 receives logging data 204 including an interaction history between the actor node and the recipient node. In some embodiments, the interaction history includes a channel on which the interaction occurred. For example, logging data 204 includes information about whether the interaction between the actor node and the recipient node was a like, a message, etc. Further details regarding receiving logging data for entities associated with the nodes of the graph network are discussed with reference to FIGS. 2-6.

At operation 715, the processing device generates weakly labeled data by filtering the logging data using the network data. For example, weak supervision labeling component 160 determines content types for posts in logging data 204 and generates labeled data 206 by filtering out posts that include useful content. Accordingly, weak supervision labeling component 160 retains interactions with posts that do not contain useful content which are more likely to correspond with close relationships between the poster and the user liking the post. In some embodiments, weak supervision labeling component 160 filters out posts/interactions from logging data 204 using profile data (e.g., network data 202) for the users associated with the relevant nodes. For example, weak supervision labeling component 160 filters out posts/interactions where the users do not share any common attributes or share very few or a certain type of attributes. Accordingly, weak supervision labeling component 160 can focus on interactions between users with shared attributes that may indicate a relationship (e.g., same college, same last name, etc.). Further details regarding generating weakly labeled data by filtering the logging data using the network data are discussed with reference to FIGS. 2-6.

At operation 720, the processing device generates training data for a relationship scoring machine learning model. For example, relationship embedding determination component 150 generates training data using relationship features 208 (e.g., recipient features 302, actor features 304, and/or pair features 402) and labeled data 206. Further details regarding generating training data for a relationship scoring model are discussed with reference to FIGS. 2-6.

At operation 725, the processing device trains the relationship scoring machine learning model to determine relationship scores for the nodes using the training data. For example, relationship embedding determination component 150 trains the relationship scoring model to generate relationship score 212 that is weakly influenced by the labeled data 206. As explained above, because relationship embedding determination component 150 uses weak supervision methods, the relationship score 212 is not forced to align with labeled data 206 but is influenced by the information included in labeled data 206. Further details regarding training the relationship scoring machine learning model to determine relationship scores are discussed with reference to FIGS. 2-6.

At operation 730, the processing device generates input data for the trained relationship scoring machine learning model. For example, relationship embedding determination component 150 generates input data for performing inference using the trained relationship scoring machine learning model. In some embodiments, relationship embedding determination component 150 generates input data 404 including relationship features 208. For example, relationship features 208 can include features for an actor node (e.g., actor features 304), features for a recipient node (e.g., recipient features 302), and features for the pair of actor and recipient (e.g., pair features 402). Further details regarding generating input data for the trained relationship scoring machine learning model are discussed with reference to FIGS. 2-6.

At operation 735, the processing device couples the trained relationship scoring machine learning model to an input of a recommendation system to provide a recommendation. For example, relationship embedding determination component 150 couples the trained relationship scoring model to machine learning model component 205 where machine learning model component 205 uses the trained relationship scoring model to determine a recommendation 214. For example, machine learning model component 205 can use the trained relationship scoring model to determine relationship scores between a user and multiple recommendation candidates and can select a recommendation for the candidate with the highest relationship score. Alternatively, machine learning model component 205 can use embeddings generated by relationship embedding determination component (e.g., embeddings 210 corresponding with recipient embedding 306, actor embedding 308, and/or pair embedding 502) when determining recommendation candidates and/or recommendation 214. Further details regarding coupling the trained relationship scoring machine learning model to an input of a recommendation system to provide a recommendation are discussed with reference to FIGS. 2-6.

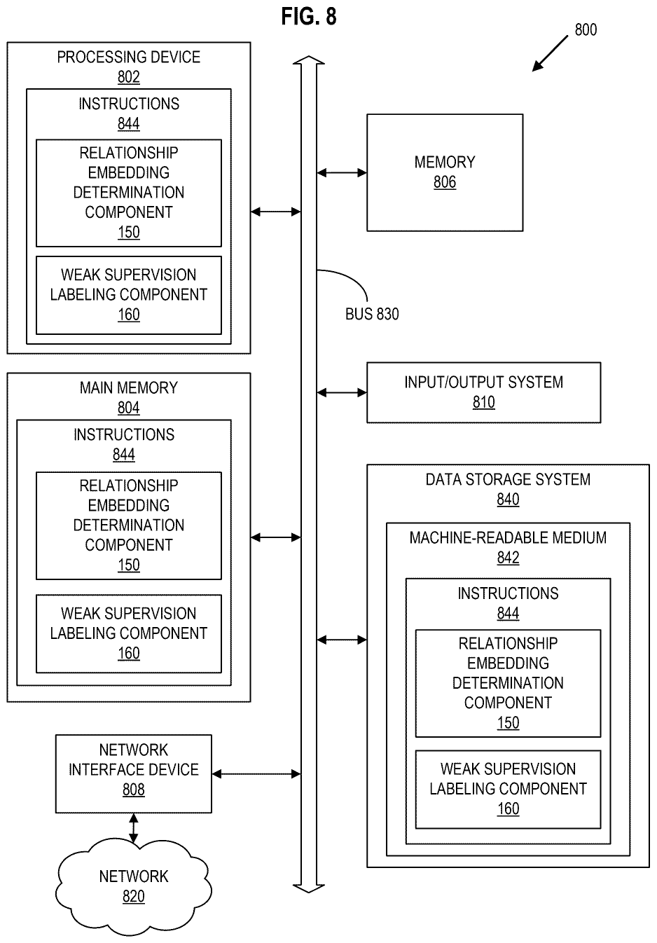

FIG. 8 illustrates an example machine of a computer system 800 within which a set of instructions for causing the machine to perform any one or more of the methodologies discussed herein, can be executed. In some embodiments, the computer system 800 can correspond to a component of a networked computer system (e.g., computing system 100 of FIG. 1) that includes, is coupled to, or utilizes a machine to execute an operating system to perform operations corresponding to relationship embedding determination component 150 and/or weak supervision labeling component 160 of FIG. 1. The machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random-access memory (DRAM) such as synchronous DRAM (SDRAM) or Rambus DRAM (RDRAM), etc.), a memory 806 (e.g., flash memory, static random-access memory (SRAM), etc.), an input/output system 810, and a data storage system 840, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 844 for performing the operations and steps discussed herein.

The computer system 800 can further include a network interface device 808 to communicate over the network 820. Network interface device 808 can provide a two-way data communication coupling to a network. For example, network interface device 808 can be an integrated-services digital network (ISDN) card, cable modem, satellite modem, or a modem to provide a data communication connection to a corresponding type of telephone line. As another example, network interface device 808 can be a local area network (LAN) card to provide a data communication connection to a compatible LAN. Wireless links can also be implemented. In any such implementation, network interface device 808 can send and receive electrical, electromagnetic or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic or optical signals that carry digital data to and from computer system computer system 800.

Computer system 800 can send messages and receive data, including program code, through the network(s) and network interface device 808. In the Internet example, a server can transmit a requested code for an application program through the Internet and network interface device 808. The received code can be executed by processing device 802 as it is received, and/or stored in data storage system 840, or other non-volatile storage for later execution.

The input/output system 810 can include an output device, such as a display, for example a liquid crystal display (LCD) or a touchscreen display, for displaying information to a computer user, or a speaker, a haptic device, or another form of output device. The input/output system 810 can include an input device, for example, alphanumeric keys and other keys configured for communicating information and command selections to processing device 802. An input device can, alternatively or in addition, include a cursor control, such as a mouse, a trackball, or cursor direction keys for communicating direction information and command selections to processing device 802 and for controlling cursor movement on a display. An input device can, alternatively or in addition, include a microphone, a sensor, or an array of sensors, for communicating sensed information to processing device 802. Sensed information can include voice commands, audio signals, geographic location information, and/or digital imagery, for example.

The data storage system 840 can include a machine-readable storage medium 842 (also known as a computer-readable medium) on which is stored one or more sets of instructions 844 or software embodying any one or more of the methodologies or functions described herein. The instructions 844 can also reside, completely or at least partially, within the main memory 804 and/or within the processing device 802 during execution thereof by the computer system 800, the main memory 804 and the processing device 802 also constituting machine-readable storage media.

In one embodiment, the instructions 844 include instructions to implement functionality corresponding to a relationship embedding determination component (e.g., relationship embedding determination component 150 of FIG. 1). In another embodiment, the instructions 844 include instructions to implement functionality corresponding to a weak supervision labeling component (e.g., weak supervision labeling component 160 of FIG. 1). In yet another embodiment, the instructions 844 include instructions to implement functionality corresponding to both a relationship embedding determination component and a weak supervision labeling component (e.g., relationship embedding determination component 150 and weak supervision labeling component 160 of FIG. 1). While the machine-readable storage medium 842 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.
Example 1. A method comprising: receiving network data for a plurality of nodes of a graph network of an online system, wherein the network data comprises information about connections between the plurality of nodes; receiving logging data for entities associated with the plurality of nodes of graph network, wherein the logging data comprises interactions between the entities associated with the plurality of nodes and content of the online system; generating weakly labeled data by filtering the logging data using the network data, wherein the weakly labeled data comprises a subset of the interactions between the entities associated with the plurality of nodes and the content of the online system; generating training data for a relationship scoring machine learning model, wherein the training data comprises input features of node pairs of the plurality of nodes and the weakly labeled data; training the relationship scoring machine learning model to determine relationship scores for the plurality of nodes by using the training data; generating input data for the trained relationship scoring machine learning model, wherein the input data comprises input features associated with a first node of the plurality of nodes and input features associated with a second node of the plurality of nodes; and coupling the trained relationship scoring machine learning model to an input of a recommendation system to provide a recommendation.
Example 2. The method of example 1, wherein generating the training data for the relationship scoring machine learning model further comprises: generating training data comprising pair features for the node pairs.
Example 3. The method of any of examples 1 and 2, wherein the relationship scoring machine learning model includes a first model tower and a second model tower, the method further comprising: training the first model tower to generate a first node embedding for a first node of the plurality of nodes using first node features of the input features; and training the second model tower to generate a second node embedding for a second node of the plurality of nodes using second node features of the input features.
Example 4. The method of example 3, wherein training the relationship scoring machine learning model to determine relationship scores comprises: training the relationship scoring machine learning model to determine a relationship score for a pair of the first node and the second node using the first node embedding and the second node embedding.
Example 5. The method of any of examples 3 and 4, wherein the relationship scoring machine learning model further includes a third model tower, the method further comprising: training the third model tower to generate a node pair embedding using pair features for a pair of the first node and the second node.
Example 6. The method of any of examples 1-5, further comprising: generating training data comprising pair features for the node pairs.
Example 7. The method of any of example 1-6, wherein filtering the logging data using the network data comprises: determining shared features for the node pairs using the network data; and filtering the logging data using the shared features.
Example 8. The method of any of example 1-7, wherein filtering the logging data using the network data comprises: determining content types for the logging data by applying a trained machine learning model to the logging data; and filtering the logging data using the content types.
Example 9. The method of any of examples 1-8, wherein: generating the training data comprises generating training data for a plurality of channels; and training the relationship scoring machine learning model to determine relationship score comprises training the relationship scoring machine learning model to determine a plurality of channel relationship scores and a plurality of channel weights, wherein determining the relationship score uses the plurality of channel relationship scores and the plurality of channel weights.
Example 10. The method of any of examples 1-9, wherein generating the weakly labeled data comprises: generating the weakly labeled data using an autoencoder.
Example 11. A system comprising: at least one memory device; and a processing device, operatively coupled with the at least one memory device, to: receive network data for a plurality of nodes of a graph network of an online system, wherein the network data comprises information about connections between the plurality of nodes; receive logging data for entities associated with the plurality of nodes of graph network, wherein the logging data comprises interactions between the entities associated with the plurality of nodes and content of the online system; generate weakly labeled data by filtering the logging data using the network data, wherein the weakly labeled data comprises a subset of the interactions between the entities associated with the plurality of nodes and the content of the online system; generate training data for a relationship scoring machine learning model, wherein the training data comprises input features of node pairs of the plurality of nodes and the weakly labeled data; train the relationship scoring machine learning model to determine relationship scores for the plurality of nodes by using the training data; generate input data for the trained relationship scoring machine learning model, wherein the input data comprises input features associated with a first node of the plurality of nodes and input features associated with a second node of the plurality of nodes; and couple the trained relationship scoring machine learning model to an input of a recommendation system to provide a recommendation.
Example 12. The system of example 11, wherein generating the training data for the relationship scoring machine learning model further comprises: generating training data comprising pair features for the node pairs.
Example 13. The system of any of examples 11 and 12, wherein the relationship scoring machine learning model includes a first model tower and a second model tower and wherein the processing device is further to: train the first model tower to generate a first node embedding for a first node of the plurality of nodes using first node features of the input features; and train the second model tower to generate a second node embedding for a second node of the plurality of nodes using second node features of the input features.
Example 14. The system of example 13, wherein training the relationship scoring machine learning model to determine relationship scores comprises: training the relationship scoring machine learning model to determine a relationship score for a pair of the first node and the second node using the first node embedding and the second node embedding.
Example 15. The system of any of examples 13 and 14, wherein the relationship scoring machine learning model further includes a third model tower and wherein the processing device is further to: train the third model tower to generate a node pair embedding using pair features for a pair of the first node and the second node.
Example 16. The system of any of examples 11-15, wherein the processing device is further to: generate training data comprising pair features for the node pairs.
Example 17. The system of any of example 11-16, wherein filtering the logging data using the network data comprises: determining shared features for the node pairs using the network data; and filtering the logging data using the shared features.
Example 18. The system of any of examples 11-17, wherein filtering the logging data using the network data comprises: determining content types for the logging data by applying a trained machine learning model to the logging data; and filtering the logging data using the content types.
Example 19. The system of any of examples 11-18, wherein generating the weakly labeled data comprises: generating the weakly labeled data using an autoencoder.
Example 20. A system comprising: at least one memory device; and a processing device, operatively coupled with the at least one memory device, to: receive network data for a plurality of nodes of a graph network of an online system, wherein the network data comprises information about connections between the plurality of nodes for a plurality of channels; receive logging data for entities associated with the plurality of nodes of graph network, wherein the logging data comprises interactions between the entities associated with the plurality of nodes and content of the online system for the plurality of channels; generate weakly labeled data by filtering the logging data using the network data, wherein the weakly labeled data comprises a subset of the interactions between the entities associated with the plurality of nodes and the content of the online system for the plurality of channels; generate training data for a relationship scoring machine learning model, wherein the training data comprises input features of node pairs of the plurality of nodes and the weakly labeled data; train the relationship scoring machine learning model to determine: a plurality of channel relationship scores for the plurality of nodes by using the training data; a plurality of channel weights for the plurality of channels using the training data; and relationship scores for the plurality of nodes using the plurality of channel relationship scores and the plurality of channel weights; generate input data for the trained relationship scoring machine learning model, wherein the input data comprises input features associated with a first node of the plurality of nodes and input features associated with a second node of the plurality of nodes; and couple the trained relationship scoring machine learning model to an input of a recommendation system to provide a recommendation.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100, can carry out the computer-implemented method 700 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

Illustrative examples of the technologies disclosed herein are provided below. An embodiment of the technologies may include any of the examples or a combination of the described below.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving network data for a plurality of nodes of a graph network of an online system, wherein the network data comprises information about connections between the plurality of nodes;
receiving logging data for entities associated with the plurality of nodes of graph network, wherein the logging data comprises interactions between the entities associated with the plurality of nodes and content of the online system;
generating weakly labeled data by filtering the logging data using the network data, wherein the weakly labeled data comprises a subset of the interactions between the entities associated with the plurality of nodes and the content of the online system;
generating training data for a relationship scoring machine learning model, wherein the training data comprises input features of node pairs of the plurality of nodes and the weakly labeled data;
training the relationship scoring machine learning model to determine relationship scores for the plurality of nodes by using the training data;
generating input data for the trained relationship scoring machine learning model, wherein the input data comprises input features associated with a first node of the plurality of nodes and input features associated with a second node of the plurality of nodes; and
coupling the trained relationship scoring machine learning model to an input of a recommendation system to provide a recommendation.

2. The method of claim 1, wherein generating the training data for the relationship scoring machine learning model further comprises:
generating training data comprising pair features for the node pairs.

3. The method of claim 1, wherein the relationship scoring machine learning model includes a first model tower and a second model tower, the method further comprising:
training the first model tower to generate a first node embedding for a first node of the plurality of nodes using first node features of the input features; and
training the second model tower to generate a second node embedding for a second node of the plurality of nodes using second node features of the input features.

4. The method of claim 3, wherein training the relationship scoring machine learning model to determine relationship scores comprises:
training the relationship scoring machine learning model to determine a relationship score for a pair of the first node and the second node using the first node embedding and the second node embedding.

5. The method of claim 3, wherein the relationship scoring machine learning model further includes a third model tower, the method further comprising:
training the third model tower to generate a node pair embedding using pair features for a pair of the first node and the second node.

6. The method of claim 1, further comprising:
generating training data comprising pair features for the node pairs.

7. The method of claim 1, wherein filtering the logging data using the network data comprises:
determining shared features for the node pairs using the network data; and
filtering the logging data using the shared features.

8. The method of claim 1, wherein filtering the logging data using the network data comprises:
determining content types for the logging data by applying a trained machine learning model to the logging data; and
filtering the logging data using the content types.

9. The method of claim 1, wherein:
generating the training data comprises generating training data for a plurality of channels; and
training the relationship scoring machine learning model to determine relationship score comprises training the relationship scoring machine learning model to determine a plurality of channel relationship scores and a plurality of channel weights, wherein determining the relationship score uses the plurality of channel relationship scores and the plurality of channel weights.

10. The method of claim 1, wherein generating the weakly labeled data comprises:
generating the weakly labeled data using an autoencoder.

11. A system comprising:
at least one memory device; and
a processing device, operatively coupled with the at least one memory device, to:
receive network data for a plurality of nodes of a graph network of an online system, wherein the network data comprises information about connections between the plurality of nodes;
receive logging data for entities associated with the plurality of nodes of graph network, wherein the logging data comprises interactions between the entities associated with the plurality of nodes and content of the online system;
generate weakly labeled data by filtering the logging data using the network data, wherein the weakly labeled data comprises a subset of the interactions between the entities associated with the plurality of nodes and the content of the online system;
generate training data for a relationship scoring machine learning model, wherein the training data comprises input features of node pairs of the plurality of nodes and the weakly labeled data;
train the relationship scoring machine learning model to determine relationship scores for the plurality of nodes by using the training data;
generate input data for the trained relationship scoring machine learning model, wherein the input data comprises input features associated with a first node of the plurality of nodes and input features associated with a second node of the plurality of nodes; and
couple the trained relationship scoring machine learning model to an input of a recommendation system to provide a recommendation.

12. The system of claim 11, wherein generating the training data for the relationship scoring machine learning model further comprises:
generating training data comprising pair features for the node pairs.

13. The system of claim 11, wherein the relationship scoring machine learning model includes a first model tower and a second model tower and wherein the processing device is further to:
train the first model tower to generate a first node embedding for a first node of the plurality of nodes using first node features of the input features; and
train the second model tower to generate a second node embedding for a second node of the plurality of nodes using second node features of the input features.

14. The system of claim 13, wherein training the relationship scoring machine learning model to determine relationship scores comprises:
training the relationship scoring machine learning model to determine a relationship score for a pair of the first node and the second node using the first node embedding and the second node embedding.

15. The system of claim 13, wherein the relationship scoring machine learning model further includes a third model tower and wherein the processing device is further to:
train the third model tower to generate a node pair embedding using pair features for a pair of the first node and the second node.

16. The system of claim 11, wherein the processing device is further to:
generate training data comprising pair features for the node pairs.

17. The system of claim 11, wherein filtering the logging data using the network data comprises:
determining shared features for the node pairs using the network data; and
filtering the logging data using the shared features.

18. The system of claim 11, wherein filtering the logging data using the network data comprises:
determining content types for the logging data by applying a trained machine learning model to the logging data; and
filtering the logging data using the content types.

19. The system of claim 11, wherein generating the weakly labeled data comprises:
generating the weakly labeled data using an autoencoder.

20. A system comprising:
at least one memory device; and
a processing device, operatively coupled with the at least one memory device, to:
receive network data for a plurality of nodes of a graph network of an online system, wherein the network data comprises information about connections between the plurality of nodes for a plurality of channels;
receive logging data for entities associated with the plurality of nodes of graph network, wherein the logging data comprises interactions between the entities associated with the plurality of nodes and content of the online system for the plurality of channels;
generate weakly labeled data by filtering the logging data using the network data, wherein the weakly labeled data comprises a subset of the interactions between the entities associated with the plurality of nodes and the content of the online system for the plurality of channels;
generate training data for a relationship scoring machine learning model, wherein the training data comprises input features of node pairs of the plurality of nodes and the weakly labeled data;
train the relationship scoring machine learning model to determine:
a plurality of channel relationship scores for the plurality of nodes by using the training data;
a plurality of channel weights for the plurality of channels using the training data; and
relationship scores for the plurality of nodes using the plurality of channel relationship scores and the plurality of channel weights;
generate input data for the trained relationship scoring machine learning model, wherein the input data comprises input features associated with a first node of the plurality of nodes and input features associated with a second node of the plurality of nodes; and
couple the trained relationship scoring machine learning model to an input of a recommendation system to provide a recommendation.
